(19) United States
(12) Patent Application Publication
(10) Pub. No.: US 2025/0064264 A1
(43) Pub. Date: Feb. 27, 2025

(54) EXTRUSION LEVER MECHANISM FOR A MICRO PUREE MACHINE

(71) Applicant: SharkNinja Operating LLC, Needham, MA (US)

(72) Inventors: Jonathan James, Witney (GB); Nathan Lyell, Surrey (GB)

(73) Assignee: SharkNinja Operating LLC, Needham, MA (US)

(21) Appl. No.: 18/531,807

(22) Filed: Dec. 7, 2023

Related U.S. Application Data
(60) Provisional application No. 63/578,744, filed on Aug. 25, 2023.

(51) Int. Cl. A47J 43/07

(52) U.S. Cl. CPC A47J 43/07

(57) ABSTRACT

An extrusion lever mechanism is configured to change the extrusion state of a micro puree machine via electronic control. This control can be either manual or automatic, as selected by the user. The extrusion lever mechanism is also configured to provide a way for the user to retract an extruding plunger in order to remove the processing bowl from the machine.

### CROSS-REFERENCE TO RELATED APPLICATIONS

This application claims priority to and benefit of U.S. Provisional Application No. 63/578,744, filed on Aug. 25, 2023, entitled EXTRUSION LEVER MECHANISM FOR A MICRO PUREE MACHINE, the entire contents of which are incorporated herein by reference for all purposes.

### FIELD

The present disclosure relates to a food processing device and, more particularly, to a micro puree machine with an extrusion lever for dispensing ingredients from the processing bowl.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

An alternative type of machine known for making a frozen food product may be referred to as a micro-puree machine. Typically, machines of this nature spin and plunge a blade into a pre-frozen ingredient or combination of ingredients. While able to make frozen desserts like ice creams, gelatos, frozen yogurts, sorbets and the like, micro puree machines can also prepare non-dessert types of foods such as non-dessert purees and mousses.

### SUMMARY

The disclosure describes an extrusion lever mechanism designed to change the extrusion state of a micro puree machine via electronic control. In some embodiments of the disclosure, this control can be either manual or automatic, as selected by the user. The extrusion lever mechanism may be configured to provide a way for the user to retract an extruding plunger in order to remove the processing bowl from the machine.

In some embodiments, the extrusion lever mechanism includes an extrusion lever and a hub configured to receive a portion of the extrusion lever. The hub includes a plurality of inclined planes extending around a diameter of the hub. The extrusion lever mechanism also includes a pin rotationally keyed to the extrusion lever. Each of a manual extrusion position, a neutral position, and a storage position of the extrusion lever corresponds to a position of the pin relative to the plurality of inclined planes.

In some embodiments, the manual extrusion position of the extrusion lever initiates extrusion of processed ingredients from a bowl of the micro puree machine with user input.

In some embodiments, the manual extrusion position of the extrusion lever is between a vertical position and a first radial position.

In some embodiments, the neutral position of the extrusion lever is a vertical position.

In some embodiments, the storage position of the extrusion lever is on a horizontal plane pointing away from a user.

In some embodiments, an automatic extrusion position of the extrusion lever initiates extrusion of processed ingredients from a bowl of the micro puree machine without user input.

In some embodiments, the automatic extrusion position of the extrusion lever is between a vertical position and a second radial position.

In some embodiments, a retraction position of the extrusion lever initiates retraction of a plunger from a bowl of the micro puree machine without user input.

In some embodiments, the retraction position of the extrusion lever is between a vertical position and a third radial position.

In some embodiments, the extrusion lever mechanism further includes at least one microswitch configured to provide information about the position of the extrusion lever to a printed circuit board.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1A shows an assembled view of a micro puree machine according to an illustrative embodiment of the disclosure;

FIG. 1B shows the micro puree machine FIG. 1A in a disassembled view according to some embodiments of the disclosure;

FIG. 2 is a detailed view of the coupling and the processing shaft of the micro puree machine according to some embodiments of the disclosure;

FIGS. 3A and 3B illustrate rotation of the bowl into the coupling of the micro puree machine according to some embodiments of the disclosure;

FIGS. 4A-4D illustrate the use of the blade and extrusion assemblies according to some embodiments of the disclosure;

FIG. 5A shows another assembled view of a micro puree machine according to some embodiments of the disclosure; and

FIGS. 5B-5E illustrate an extrusion lever mechanism of the micro puree machine of FIG. 5A according to some embodiments of the disclosure.

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

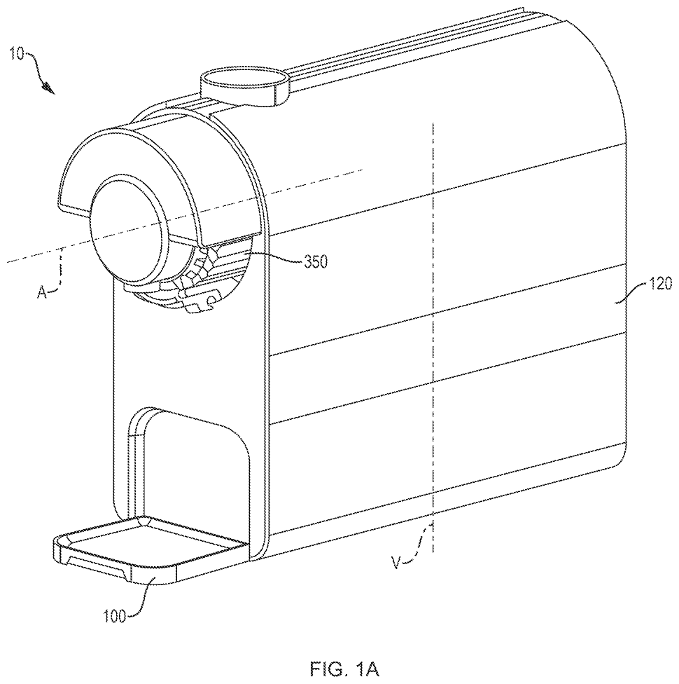

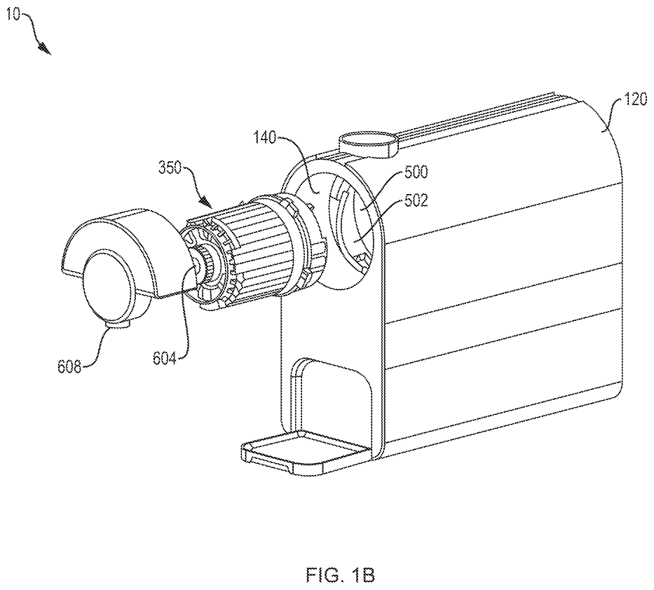

FIG. 1A shows an isometric view of a micro puree machine 10 according to an illustrative embodiment of the disclosure. The micro puree machine 10 may include a base 100 and a housing 120. The housing 120 may include a user interface (not shown) for receiving user inputs to control the micro puree machine 10 and/or display information. The micro puree machine 10 may also include a processing bowl 350, as further described below. The processing bowl 350 may contain one or more ingredients for processing. The processing bowl 350 may be assembled to the housing 120 such that a central axis A of the processing bowl 350 extends perpendicular to a vertical axis V of the housing 120, as shown. However, the disclosure contemplates that the processing bowl 350 may be assembled to the housing 120 such that the central axis A extends at an angle of between 0 and 90° to the vertical axis V, or such that the central axis A extends parallel to the vertical axis V. In embodiments, the processing bowl 350 can be manufactured from a disposable material to enhance the convenience of using the micro puree machine 10. Further, the processing bowl 350 can be sold as a stand-alone item and can also be prefilled with ingredients to be processed during use of the micro puree machine 10.

FIG. 1B shows the micro puree machine 10 of FIG. 1A with the processing bowl 350 disassembled from the housing 120 according to some embodiments. As shown in FIG. 1B, the housing 120 may including a coupling 500 disposed within an opening 140 of the housing 120. An inner surface 502 of the coupling 500 may comprise locating and locking elements for positioning and connecting the processing bowl 350 to the coupling 500, as further described below. The processing bowl 350 may include an opening 604 alignable with a nozzle 608 for extruding processed ingredients from the processing bowl 350. The nozzle 608 may be arranged such that the ingredients are extruded in a vertically downward direction. The disclosure also contemplates that multiple nozzle shapes may be provided to allow for user customizability. For example, multiple nozzles may be included on a rotatable dial that allows the user to select the desired nozzle shape. In further embodiments, the extrude function may be integrated into a program on the user interface with a predetermined translation speed/flow rate.

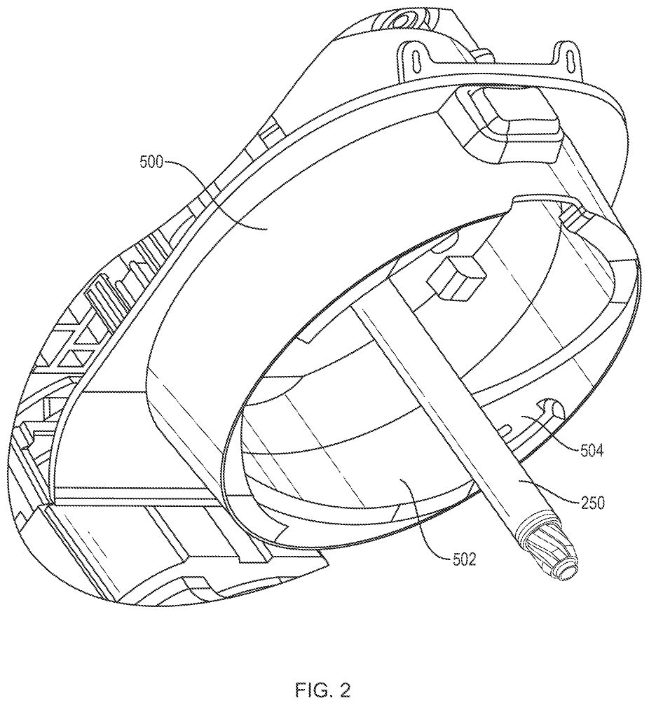

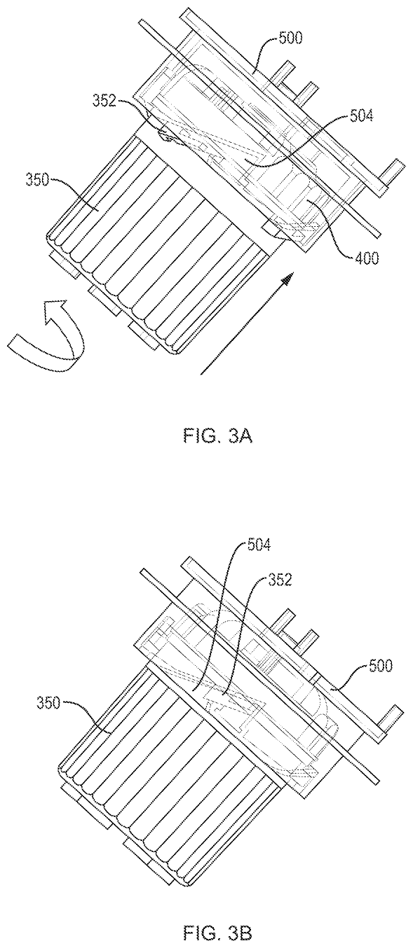

FIG. 2 is a detailed view of the coupling 500 and the processing shaft 250 of the micro puree machine 10 according to some embodiments. As shown in FIG. 2, the processing shaft 250 may extend through the coupling 500 to couple with either a blade or a plunger housed within a lid on the processing bowl 350. The inner surface 502 of the coupling 500 may comprise one or more helical slots 504 sized to receive at least one corresponding helical projection 352 (FIG. 3A) on an outer surface of the processing bowl 350. In embodiments, the at least one helical slot 504 may be four helical slots 504 spaced 90 degrees apart about the inner surface 502 of the coupling 500 for receiving a corresponding one of four helical projections 352 on the processing bowl 350. However, the disclosure contemplates more or fewer than four helical slots 504.

FIG. 3A shows the processing bowl 350 inserted into the coupling 500 (shown in a transparent view for ease of illustration) but before the processing bowl 350 is secured to the coupling 500 according to some embodiments. As shown in FIG. 3A, the user may rotate the processing bowl 350 relative to the coupling 500 in a first direction (e.g., clockwise) such that the protrusions 352 rotate into the slots 504, securing the processing bowl 350 to the coupling 500 (FIG. 3B). Because of the angle of the slots 504 and the protrusions 352, rotating the processing bowl 350 relative to the coupling 500 may cause the processing bowl 350 to move both rotationally and axially within the coupling 500.

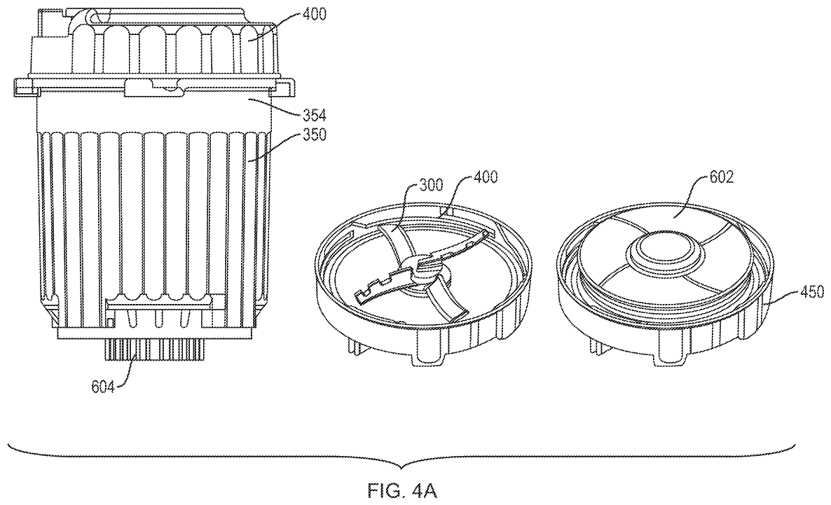

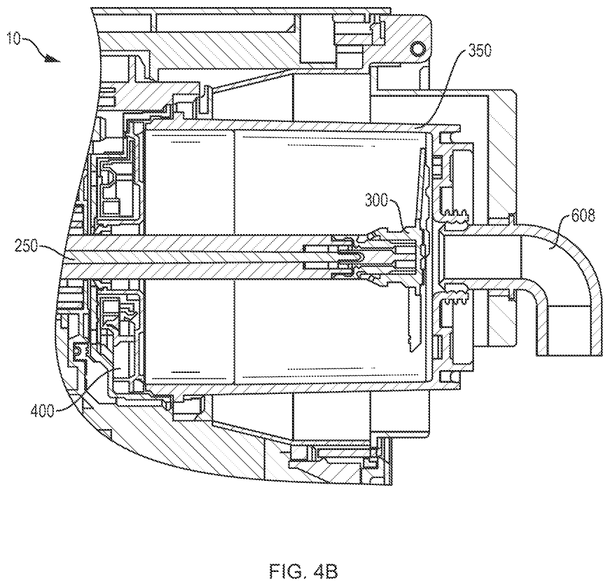

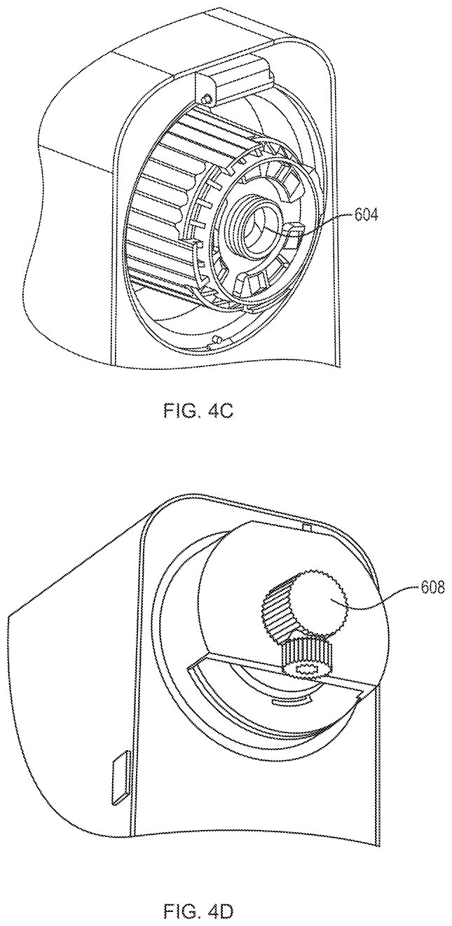

FIGS. 4A-4D illustrate the use of the blade 300 and the plunger 602 according to some embodiments of the disclosure. As shown in FIG. 4A, an open end 354 of the processing bowl 350 may be configured to couple to both a first lid 400 housing the blade 300 and a second lid 450 housing the plunger 602. As shown in FIG. 4B, the user may attach the first lid 400 to the processing bowl 350 and couple to the processing bowl 350 to the micro puree machine 10. The processing shaft 250 may couple to the blade 300 to descend the blade 300 within the processing bowl 350 to process the ingredients. The user may then remove the processing bowl 350 from the micro puree machine 10 and remove the first lid 400. The user may then attach the second lid 450 to the processing bowl 350 and couple the processing bowl 350 to the micro puree machine 10. The processing shaft 250 may couple to the plunger 602 to descend the plunger 602 through the processed ingredients. This in turn may cause the processed ingredients to be extruded through the opening 604 (FIG. 4C) and through the nozzle 608 (FIG. 4D).

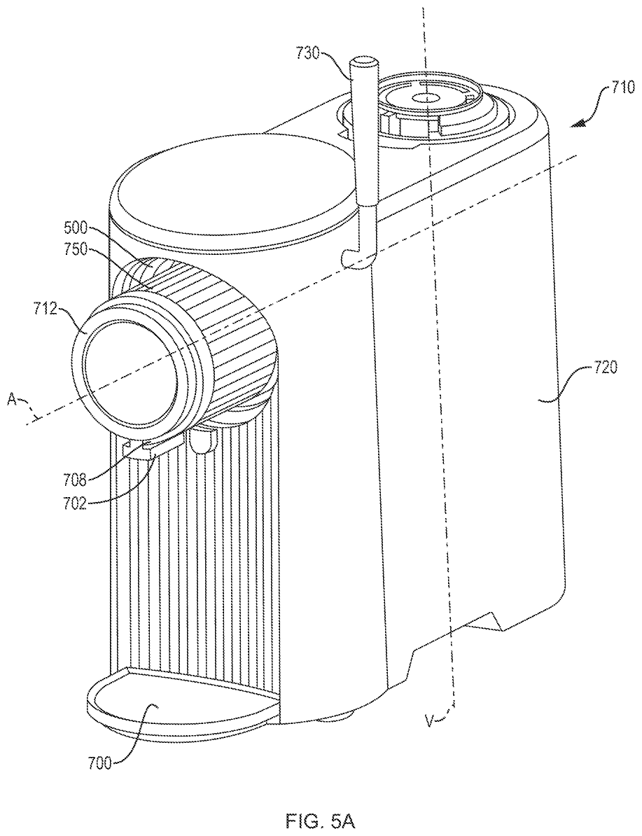

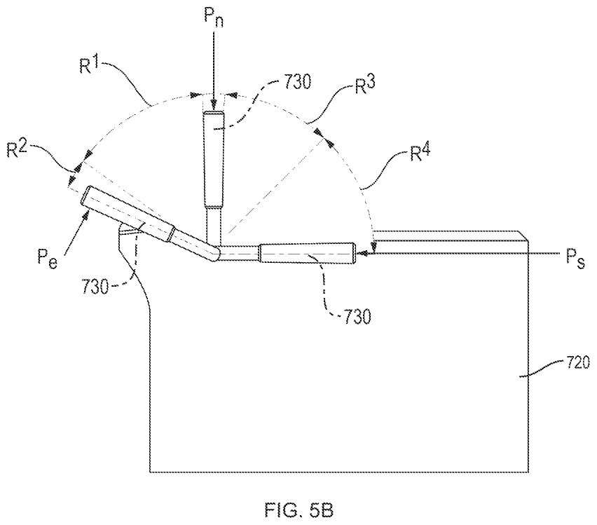

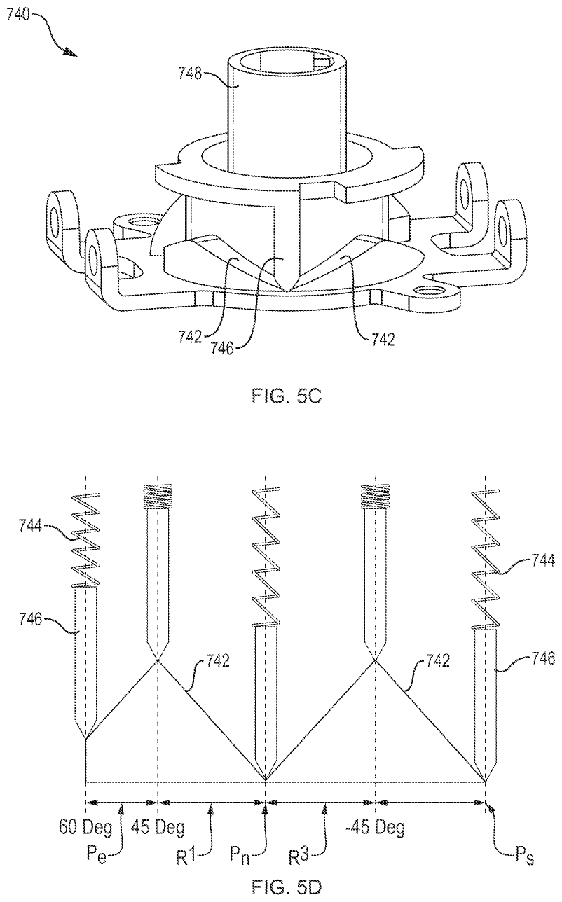

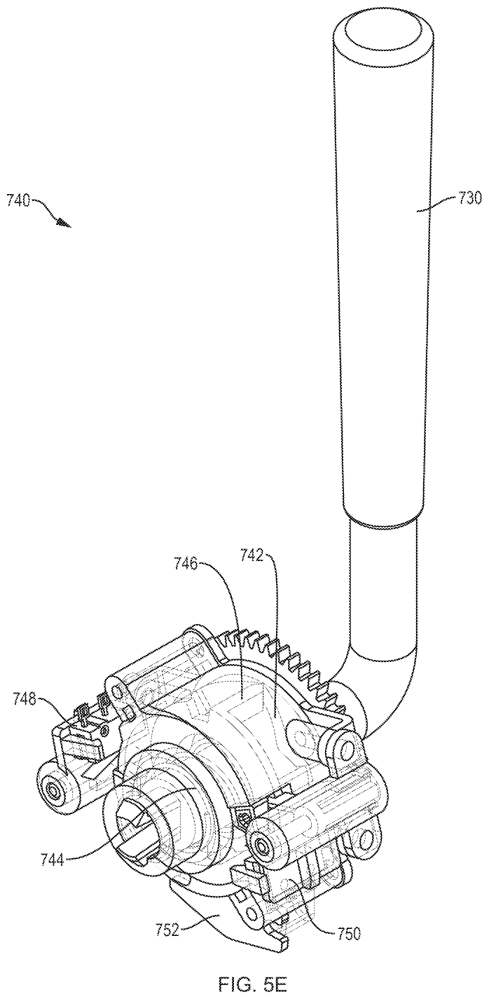

FIG. 5A shows an isometric view of a micro puree machine 710 according to another illustrative embodiment of the disclosure. The micro puree machine 710 may include a base 700 and a housing 720. The housing 720 may include a user interface (not shown) for receiving user inputs to control the micro puree machine 710 and/or display information. The micro puree machine 710 may also include the processing bowl 750. The processing bowl 750 may be assembled to the housing 720 such that a central axis A of the processing bowl 750 extends perpendicular to a vertical axis V of the housing 720, as shown. However, the disclosure contemplates that the processing bowl 750 may be assembled to the housing 720 such that the central axis A extends at an angle of between 0 and 90° to the vertical axis V, or such that the central axis A extends parallel to the vertical axis V. A nozzle 708 may be integrated with the bottom edge of the processing bowl 750. In embodiments, the processing bowl 750 may be configured to be installed to the coupling 500 such that the nozzle 708 faces vertically downwards when the processing bowl 750 is properly installed. The processing bowl 750 may have a hinged plug 702 that is spring loaded into an open position. The plug 702 may be held and locked in the closed position by a front cap 712 with a CAM path (not shown) that the plug 702 slots into. The front cap 712 may also be spring loaded rotationally in the closed position. In order to open the plug 702, the user may twist the front cap 712 in a first direction (e.g., counterclockwise), causing the hinged plug 702 to be released from the CAM and spring into the open position. To close the plug 702, the user may manually hinge the plug 702 back into the closed position, causing the front cap 712 to twist using the CAM to capture the plug 702. The micro puree machine 710 may further include an extrusion lever 730 for controlling the extrusion of ingredients through the nozzle 708, as further described below.

FIG. 5B illustrates the various positions of the extrusion lever 730 relative to the housing 720 according to some embodiments. As shown in FIG. 5B, the extrusion lever 730 may provide an electro-mechanical system for a user to interact with. The neutral position Pₙ of the lever 730 may be vertical. The user can pull the lever 730 towards them (i.e., between a vertical position and a first radial position, such as 45 degrees) in order to activate manual extrusion of the plunger 602 (FIG. 4A). The extrusion lever 703 may be configured such that, throughout this range of angles R¹, the lever 730 must be held by the user to maintain extrusion, as the lever 730 is configured to naturally be sprung toward the neutral position Pₙ. The extrusion lever 730 may furthermore be configured such that, if the range of angles exceeds the first radial position, the lever 730 transitions to an automatic extrusion position Pₑ. This state may spring the lever 730 through a range of angles R² towards a second radial position (e.g., 60 degrees toward the user from the neutral position Pₙ) and may lock the lever 730 in place until pushed back past the first position by the user. When in the extrusion position Pₑ, the extrusion state may be locked on without the need for user operation (i.e., the user does not need to hold it in place).

Still referring to FIG. 5B, from the neutral position Pₙ, the user can push the lever 730 away from them (i.e., between a vertical position and a third radial position, such as 45 degrees). Positioning the lever 730 in this range of angles R³ may initiate retraction of the plunger 602, for example, according to a program that runs without the need for continuous user input. If the angle exceeds the third radial position away from the user, the lever 730 may be sprung through a range of angles R⁴ towards the storage position Pₛ. The storage position Pₛ may be on a horizontal plane pointing away from the user (e.g., perpendicular to the neutral position Pₙ). Advantageously, the storage position Pₛ may reduce the overall dimensions of the machine 710, allowing for easier storage. The user may pull the lever 730 upwards from the storage position Pₛ to return the lever 730 automatically to the neutral position Pₙ.

FIGS. 5C and 5D illustrate a triple bi-stable mechanism 740 for controlling the position of the lever 730 according to some embodiments of the disclosure. As shown in FIG. 5C, the mechanism 740 may comprise a plurality of inclined planes 742 that map around a diameter of a hub 748 configured to receive a portion of the lever 730. A pin 746 that is rotationally keyed to the lever 730 may be configured to rotate about the hub 748 to engage the inclined planes 742. As shown schematically in FIG. 5D, a spring 744 may be configured to force the pin 746 into the most stable angle—that is, the lowest point of intersection of two adjacent inclined planes 742. The spring 744 may force the lever 730 to rotate to the position of the intersection when all user inputs are removed. The pin 746 may rotate with the lever 730 but may also be able to slide relative to the lever 730. This may allow the pin 746 to track up the height of the next inclined plane 742 without causing translation to the lever 730. The position of the intersection of the inclined plane 742 may dictate the angle at which the lever 730 changes stable state, which can be defined to be any angle required.

FIG. 5E illustrates the arrangement of the lever 730, inclined planes 742, the pin 746, and the spring 744 of the mechanism 740 according to some embodiments. As shown in FIG. 5E, the mechanism may further include two micro switches 748, 750 that provide information about the angle of the lever 730 to a printed circuit board (PCB). A maximum of one microswitch 748, 750 may be active at a time. One microswitch 750 may be used for the extrusion state while the other microswitch 748 may be used for the plunger retraction state. In the neutral position Pₙ and the storage position Pₛ, neither microswitch is active. The disclosure also contemplates that this information could be provided to the PCB with the use of pogo pins that interact with slip rings, which may provide for better angular accuracy. The mechanism 740 can further have resistance added with the use of a damper 752, such as a rotary damper.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

We claim:

1. An extrusion lever mechanism for a micro puree machine, the extrusion lever mechanism comprising:
an extrusion lever;
a hub configured to receive a portion of the extrusion lever, the hub comprising a plurality of inclined planes extending around a diameter of the hub; and
a pin rotationally keyed to the extrusion lever;
wherein each of a manual extrusion position, a neutral position, and a storage position of the extrusion lever corresponds to a position of the pin relative to the plurality of inclined planes.

2. The extrusion lever mechanism of claim 1, wherein the manual extrusion position of the extrusion lever initiates extrusion of processed ingredients from a bowl of the micro puree machine with user input.

3. The extrusion lever mechanism of claim 1, wherein the manual extrusion position of the extrusion lever is between a vertical position and a first radial position.

4. The extrusion lever mechanism of claim 1, wherein the neutral position of the extrusion lever is a vertical position.

5. The extrusion lever mechanism of claim 1, wherein the storage position of the extrusion lever is on a horizontal plane pointing away from a user.

6. The extrusion lever mechanism of claim 1, wherein an automatic extrusion position of the extrusion lever initiates extrusion of processed ingredients from a bowl of the micro puree machine without user input.

7. The extrusion lever mechanism of claim 6, wherein the automatic extrusion position of the extrusion lever is between a vertical position and a second radial position.

8. The extrusion lever mechanism of claim 1, wherein a retraction position of the extrusion lever initiates retraction of a plunger from a bowl of the micro puree machine without user input.

9. The extrusion lever mechanism of claim 8, wherein the retraction position of the extrusion lever is between a vertical position and a third radial position.

10. The extrusion lever mechanism of claim 1, further comprising at least one microswitch configured to provide information about the position of the extrusion lever to a printed circuit board.
